(19) United States
(12) Patent Application Publication
(10) Pub. No.: US 2006/0157983 A1
(43) Pub. Date: Jul. 20, 2006

(54) High pressure coupling device and method

(76) Inventors: Paul M. Lyons, Tucson, AZ (US); Edward L. Kane, Tucson, AZ (US); Phillip C. White, Tucson, AZ (US); Peter H. Jackson, Tucson, AZ (US); William J. Thomke, Tucson, AZ (US)

Correspondence Address: NOBLITT & GILMORE, LLC., 4800 NORTH SCOTTSDALE ROAD, SUITE 6000, SCOTTSDALE, AZ, 85251, US

(21) Appl. No.: 11/039,127

(22) Filed: Jan. 19, 2005

(51) Int. Cl. F16L 19/00

(52) U.S. Cl. 285/353; 285/384

(57) ABSTRACT

The disclosed system, device and method for providing a substantially leak-proof tube/manifold seal generally includes a partially deformable polymeric ferrule (100), a retaining ring (110) and a nut (130) configured to drive and deform the ferrule (100) against a receiving manifold surface (144). Disclosed features and specifications may be variously controlled, adapted or otherwise optionally modified to improve tube seal seating and/or engagement. Exemplary embodiments of the present invention generally allow for the use of tube coupling hardware (e.g., ferrules) that would otherwise need to be reworked, replaced or discarded.

### STATEMENT OF GOVERNMENTAL INTEREST

This invention was made with Government support under Contract No. N00024-03-C-6111 awarded by The Department of Navy. The Government has certain rights in this invention.

### FIELD OF INVENTION

The present invention generally relates to tube fittings; and more particularly, representative and exemplary embodiments of the present invention generally provide improved ferrule-type couplings for high pressure operating environments.

### BACKGROUND OF INVENTION

Substantial efforts have been engaged to design and fabricate tubing capable of withstanding considerable stress while performing in various operating environments. For example, significant internal stresses may be created when liquids or gases are pumped through tubing over long distances, thereby requiring flow-field containment materials capable of demonstrating high burst strength. Additionally, a pipe may be subjected to tensile or longitudinal loads generally requiring high tensile strength material. Additionally, a tube or hose may need to be flexible or resistant to external damage such as crimping, bending, cutting or abrasion.

Generally, the coupling point located at a terminal portion of a pipe must also be capable of at least meeting the same high pressure performance criteria as that of the flow-field containment material. A primary consideration in providing a suitable coupling junction is the prevention of leakage of the contents of the tube which may be under high pressure. In such operating environments, the coupling must provide an effective seal without damaging the tube.

Another consideration generally involves the tolerances required to provide a leak-proof seal. Because conventional ferrule designs have limited capabilities, extremely close fitting tolerances have been required. This is generally undesirable when sealing pipes that are subjected to high internal pressures, and may especially be the case for continuously extruded pipe, which typically has substantial variations in outer diameter.

Another important consideration is that pipes employing conventional ferrule designs may be subjected to forces in such a way that stress points are created. Over time, these stress points may become sites for cracks or fractures. Eventually the fractures may increase in size to the point where the seal leaks or the pipe fails.

Conventional ferrule designs typically have a male stem portion that is suitably adapted for engagement with a terminal end of a hose and a ferrule that is concentric with the male stem. Together, the male stem and ferrule define an annular cavity for receiving a hose end. The coupling is generally retained by pinching the hose end between the ferrule and the stem. This may be accomplished, for example, by either reducing the diameter of the ferrule or increasing the diameter of the male stem.

Techniques that have been employed to provide a ferrule-type coupling joint capable of withstanding high pressure forces include features such as, locking collars, serrated stems, and helical or annular ribs. Conventional ferrules using helical or annular ribs, however, generally require the cover to be skived from the hose so the ribs may be allowed to make direct circumferential surface contact with a reinforcement such as braided wire. Other conventional ferrules have sharp annular or helical ribs which cut through the cover and make surface contact with the reinforcement during a crimping operation. In these cases, existing ferrule-type coupling joints may be difficult to install over a flared reinforcement at the hose end when annular or helical ribs are employed. Additionally, conventional ferrules may be expensive since they must generally be turned from bar stock to a desired tolerance specification.

Soft metal inserts (e.g., copper) have been used; however, they are expensive and have a long lead time. They can generally only be used once and produce a galvanic corrosion potential. Additionally, the soft metal inserts still require a relatively good surface finish.

Conventional approaches to the leakage problem has been to produce and protect very good surface finishes on the ferrule and seat. Both mechanical polishing and electro-polishing techniques have been previously employed. Both of these methods, however, add the risk of contamination with the reworking of parts.

Accordingly, the establishment of leak-free, high pressure joints between tube/manifold junctions or tube/tube junctions has been difficult. Conventional metal-to-metal ferrules and seats generally require a very smooth surface finish without defects in order to work satisfactorily. Rework, replacement or discarding of hardware may be required if either the ferrule or manifold receiving surface becomes damaged during manufacture, assembly or use.

### SUMMARY OF THE INVENTION

In various representative aspects, the present invention provides a low-cost, system, device and method for providing a tube coupling joint capable of withstanding high pressure. Exemplary features generally include a partially deformable polymeric ferrule, a retaining ring, and a nut configured to drive and deform the ferrule against a receiving manifold surface.

Advantages of the present invention will be set forth in the Detailed Description which follows and may be apparent from the Detailed Description or may be learned by practice of exemplary embodiments of the invention. Still other advantages of the invention may be realized by means of any of the instrumentalities, methods or combinations particularly pointed out in the Claims.

### BRIEF DESCRIPTION OF THE DRAWINGS

Representative elements, operational features, applications and/or advantages of the present invention reside inter alia in the details of construction and operation as more fully hereafter depicted, described and claimed—reference being made to the accompanying drawings forming a part hereof, wherein like numerals refer to like parts throughout. Other elements, operational features, applications and/or advantages will become apparent in light of certain exemplary embodiments recited in the Detailed Description, wherein:

FIG. 1 representatively illustrates a partially exploded, three-quarter perspective view of a ferrule device in accordance with an exemplary embodiment of the present invention; and

FIG. 2 representatively depicts a partially sectioned, side elevation view of an assembled ferrule device in accordance with an exemplary embodiment of the present invention.

Elements in the Figures are illustrated for simplicity and clarity and have not necessarily been drawn to scale. For example, the dimensions of some of the elements in the Figures may be exaggerated relative to other elements to help improve understanding of various embodiments of the present invention. Furthermore, the terms “first”, “second”, and the like herein, if any, are used inter alia for distinguishing between similar elements and not necessarily for describing a sequential or chronological order. Moreover, the terms “front”, “back”, “top”, “bottom”, “over”, “under”, and the like in the Description and/or in the Claims, if any, are generally employed for descriptive purposes and not necessarily for comprehensively describing exclusive relative position. Any of the preceding terms so used may be interchanged under appropriate circumstances such that various embodiments of the invention described herein may be rendered capable of operation in other configurations and/or orientations than those explicitly illustrated or otherwise described.

### DETAILED DESCRIPTION OF EXEMPLARY EMBODIMENTS

The following representative descriptions of the present invention generally relate to exemplary embodiments and the inventors' conception of the best mode, and are not intended to limit the applicability or configuration of the invention in any way. Rather, the following description is intended to provide convenient illustrations for implementing various embodiments of the invention. As will become apparent, changes may be made in the function and/or arrangement of any of the elements described in the disclosed exemplary embodiments without departing from the spirit and scope of the invention.

Various representative implementations of the present invention may be applied to any system for providing coupling of pipe-to-manifold junctions and/or pipe-to-pipe junctions for high pressure operating environments. As used herein, the terms “tube” and “pipe”, or any variation or combination thereof, are generally intended to include anything that may be regarded as at least being susceptible to characterization as, or generally referring to, a fluid flow field containment volume.

A detailed description of an exemplary application, namely a ferrule/ring coupling junction for a gas chromatograph, is provided as a specific enabling disclosure that may be generalized to any application of the disclosed system, device and method for providing a substantially leak-proof seal in accordance with various embodiments of the present invention.

In generally, the present invention replaces conventional swaged-on (or brazed-on) metal ferrule with a polymer ferrule and metal retaining ring. The soft ferrule provides robust sealing against relatively rough seat finishes. The soft ferrule can also be replaced if it is damaged, since it is neither swaged nor brazed on. In one exemplary embodiment, a permanently attached (braze, weld, etc.) retaining ring allows use with very high pressures. The soft ferrule and retaining ring may be suitably adapted or otherwise configured to mate to any standard (or custom) seat.

Various representative embodiments of the present invention employ a polymer (Vespel polyimide, for example) ferrule. The soft ferrule may be configured to mate with any standard fittings, an accordingly does not require a custom seat. Various embodiments of the present invention have been tested to use with pressures exceeding 7000 psi. The retaining ring and general soft ferrule design is such that the ferrule is captured and minimizes the ability of the ferrule engagement surface to creep and lose preload over time. The soft ferrule provides substantially leak-free sealing against poor surface finished seats that would otherwise require rework, replacement or disposal. In certain exemplary embodiments, soft ferrules in accordance with the present invention are replaceable or even disposable.

Any suitable soft material may be used to fabricate the ferrule. Vespel is a high-performance polyimide resin that is an exemplary polymeric material that performs well with or without lubrication under conditions which would destroy other plastics or severely gall or wear many metals. Vespel parts function over a wide range of temperatures and stresses while retaining suitable creep, abrasion resistance and strength under adverse conditions. Additionally, Vespel generally does not soften and is thermally resistant. Accordingly, Vespel polyimide can carry loads at temperatures beyond the range of most plastic materials while exhibiting extremely low creep.

Vespel may be obtained in various resin formulations including, for example, the following:

(SP-1) Unfilled, which provided physical properties and improved electrical and thermal insulation;

(SP-21) 15% graphite filled, which provides low wear and friction for bearings, thrust washers and dynamic seals;

(SP-22) 40% graphite filled, which provides improved dimensional stability and has a low coefficient of thermal expansion;

(SP-211) 15% graphite/10% filled, which has an improved coefficient of friction over a wide range of operating conditions, as well as a low wear rate up to about 300 degrees F.; and

(SP-3) 15% molybdenum disulfide filled, which provides lubrication for seals and bearings in vacuum or dry environments.

Other properties of Vespel polyimide include: low wear and friction at high pressures and flow velocities; excellent creep resistance; lubricated and un-lubricated performance; excellent impact resistance; continuous operation at temperatures up to about 500° F.; and incidental operation at excursion temperatures of up to about 900° F.

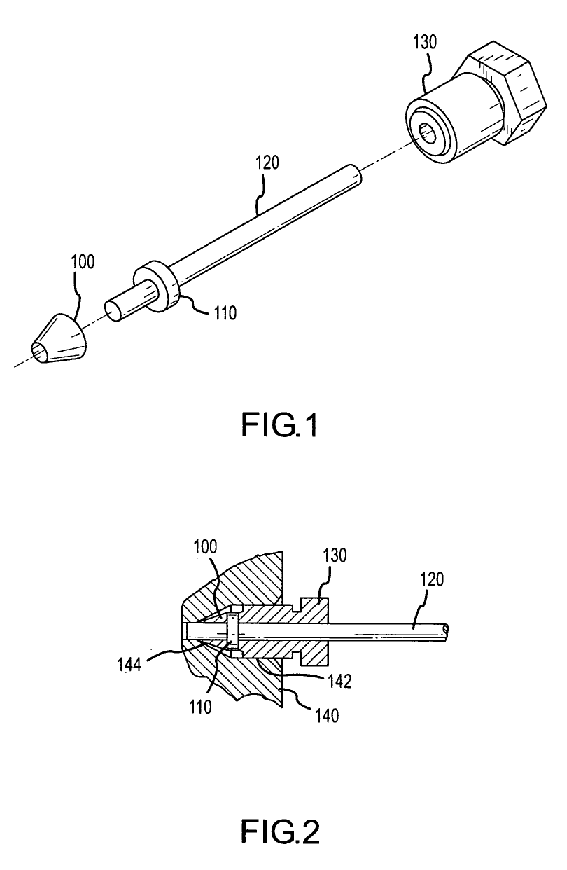

As generally illustrated in FIG. 1, a retaining ring 110 is attached to tubing 120. The present invention may be utilized with any tubing, whether now known or hereafter described in the art. Additionally, the size and/or shape of the tubing are not critical limitations placed on the present invention. Retaining ring 110 may be attached by brazing, welding, swaging, or other methods depending on the strength and convenience desired. Alternatively, conjunctively or sequentially, retaining ring 110 may be fabricated as a substantially integrated feature of the tubing at the time of manufacture of the tubing. Polymer ferrule 100 slips over the end of tube 120 (as depicted) and is generally not rigidly attached.

The ferrule/ring assembly can be mated to any standard or custom metal ferrule seat. A standard or custom back-up nut 130 may be required to preload the ferrule and impart a seal. As nut 130 is threaded against a corresponding gland, ferrule 100 is driven into a receiving manifold to establish a substantially leak-proof seal.

FIG. 2 shows the ferrule 100/ring 110 in a standard 16^{th} inch gas chromatography fitting gland 140. The standard gas chromatography back-up nut 130 threads into a standard thread 142 and manifold seat 144. FIG. 2 illustrates the ferrule 100 as it just contacts the seat 144. In use, the forces caused by the torque of nut 130 will cause the soft ferrule 100 to deform into the shape of the seat. The amount of deformation is dependant on the torque value used. Threading the nut 130 into the gland 140 forces the ferrule into the conical seat 144, tube 120 outer diameter, and retaining ring 110. This causes a seal between the ferrule(100)-and-seat(144), ferrule(100)-and-tube(120), and ferrule(100)-and-ring(110). Consequently, these seals prevent gas and/or liquid leaks.

The ferrule(100)/ring(110) assembly may be designated to geometrically conform to the specifications of a standard swage metal ferrule. The tube 120 length that extends past the ferrule 100 may be chosen to conform to the specifications of a standard interface. Accordingly, such a configuration would allow use of various embodiments of the present invention in a standard interface. It will be appreciated, however, that replication of an existing design's geometry is not necessary, but merely convenient.

The polymer ferrule 100 provides a relatively soft seat that conforms to imperfections on the seat surface 144. The attached retaining ring 110 ensures the assembly can withstand high pressure operation. The stainless steel retaining ring 110 may be attached to, for example, a 16^{th} of an inch stainless steel tubing 120 with braze. The ferrule 100 may be manufactured from Vespel polyimide in order to provide a substantially leak free seal at 7,000 psi. Testing with conventional ferrule turned from bar stock in the same seat yields leaks at just 1,000 psi.

With the present invention, a damaged ferrule may be inexpensively replaced since it is not rigidly attached. This allows simple rework with minimal opportunity for additional damage or creating contamination. Replacing a swaged (or brazed) on metal ferrule requires removing and discarding the end of the tube. The removal process adds a contamination risk to the system and the tube's length change may render the remainder of the tube's assembly unusable.

The polymer ferrule 100 of the present invention generally provides for many repeated sealings in various individual mating interfaces. Unlike a metal ferrule, the sealing ability is not permanently degraded by mating to an imperfect seat.

FIG. 2 further shows that with this invention, the soft ferrule 100 is captured by the seat 144 and retaining ring 110. This minimizes creep under long term use. The specifications of the disclosed embodiments may be altered to fully fill the seat area 144 with the ferrule 100, thereby preventing the ferrule 100 material from moving under the sealing load and minimizes creep even with creep susceptible materials.

In the foregoing specification, the invention has been described with reference to specific exemplary embodiments; however, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above.

For example, the steps recited in any method or process claims may be executed in any order and are not limited to the specific order presented in the claims. Additionally, the components and/or elements recited in any apparatus claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

We claim:

1. In a tube coupling device for providing a substantially leak-proof seal, the combination comprising:
a ferrule, said ferrule comprising an at least partially deformable polymeric material;
a retaining ring, said retaining ring suitably adapted for substantially annular disposition around a portion of tubing; and
a back-up nut, said nut suitably adapted to provide a drive force for seating the ferrule against a receiving manifold surface and deforming the ferrule within the receiving manifold to provide a substantially leak-proof seal.

2. The device of claim 1, wherein said ferrule has at least one of an at least partially tapering external surface, a substantially flat external surface, and an at least partially cylindrical interior surface.

3. The device of claim 2, wherein at least one of said partially tapering external surface comprises a conic section.

4. The device of claim 1, wherein said soft polymeric material comprises at least one of a polyimide and Vespel polyimide.

5. The device of claim 1, wherein said retaining ring is suitably adapted for attachment to said tube portion by at least one of brazing, welding and swaging.

6. The device of claim 1, wherein said retaining ring comprises a substantially integrated feature of manufacture of said tube portion.

7. The device of claim 1, wherein said retaining ring comprises at least one of a metal, a metal alloy and a polymer material.

8. The device of claim 7, wherein said retaining ring comprises stainless steel.

9. The device of claim 1, wherein said back-up nut comprises at least one of a custom nut and a standard nut.

10. The device of claim 1, wherein said back-up nut comprises at least one of a metal, a metal alloy and a polymer material.

11. The device of claim 10, wherein said back-up nut comprises stainless steel.

12. A method for providing a tube coupling that demonstrates a substantially leak-proof seal, said method comprising the steps of:
providing a ferrule, said ferrule comprising an at least partially deformable polymeric material;
providing a retaining ring, said retaining ring suitably adapted for substantially annular disposition around a portion of tubing; and
providing a back-up nut, said nut suitably adapted for at least one of seating the ferrule against a receiving manifold and deforming the ferrule within the receiving manifold to provide a substantially leak-proof seal.

13. The method of claim 12, further comprising the step of providing a portion of tubing suitably configured for establishing a substantially leak-proof seal.

14. The method of claim 13, wherein said step of providing said tube portion concurrently provides said retaining ring as a substantially integrated feature of manufacture.

15. The method of claim 13, further comprising the step of attaching said retaining ring to said tube portion by at least one of brazing, welding and swaging.

16. The method of claim 13, further comprising the step(s) of at least one of: slipping said ferrule over an end of said tube portion;
disposing a first surface of said ferrule on a first seat against a first side of said retaining ring;
disposing said back-up nut on a second seat against a second side of said retaining ring, said second side corresponding to a position substantially opposing said first side of said retaining ring;
disposing a second surface of said ferrule on a third seat against a receiving manifold surface; and
threading said back-up nut into a gland to drive and deform said second surface of said ferrule on said third seat into and against said receiving manifold surface in order to establish a substantially leak-proof seal.

17. The method of claim 16, wherein a substantially predetermine torque for driving said ferrule into said receiving manifold is used to effect a substantially predetermined amount of deformation of the polymeric material comprising said ferrule.

18. The method of claim 16, further comprising the step of replacing an at least one of worn and damage ferrule, said replacement comprising the steps of:
disassembling the ferrule coupling assembly;
replacing the ferrule with a substantially at least one of new and serviceable ferrule.

19. A tube coupling device for providing a substantially leak-proof seal, said device comprising:
a soft ferrule comprising Vespel polyimide;
a retaining ring comprising stainless steel and suitably adapted for substantially annular disposition around a portion of tubing; and
a back-up nut comprising stainless steel and suitably adapted for seating the ferrule against a receiving manifold surface and deforming the ferrule within the receiving manifold to provide a substantially leak-proof seal.

20. The device of claim 19, wherein said ferrule has at least one of an at least partially tapering external surface, a substantially flat external surface, and an at least partially cylindrical interior surface.

21. The device of claim 20, wherein at least one of said partially tapering external surface comprises a conic section.
